(19) United States
(12) Patent Application Publication
(10) Pub. No.: US 2016/0125139 A1
(43) Pub. Date: May 5, 2016

(54) System and Method for Securely Transferring Patient Medical Records

(71) Applicant: Robert Higgs, Evansville, IN (US)

(72) Inventor: Robert Higgs, Evansville, IN (US)

(21) Appl. No.: 14/528,590

(22) Filed: Oct. 30, 2014

(51) Int. Cl. G06F 19/00; H04L 29/06

(52) U.S. Cl. CPC G06F 19/322; H04L 63/083

(57) ABSTRACT

An online system and method for transmitting patient medical records among various server computers and client computers coupled together via a network or cloud system. The online system includes a personal health records module for generating, transmitting, receiving and managing patient records, and a physician's module for receiving, viewing, providing consult medical services and patient records management. The present invention provides total interoperability of patient medical records information between all present EHR/EMH electronic medical records based systems.

### CROSS REFERENCES TO RELATED APPLICATIONS

U.S. Provisional Application for Patent No. 61/897,395, filed Oct. 30, 2013, with title “Web-Based Medical Records Software Patient/Physician Interface Plug-In Application” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present disclosure relates to a system and method for capturing, storing, retrieving, and transmitting patient medical records, including longitudinal history and imaging throughout the healthcare system environment, and more particularly, to a system and method for securely communicating patient medical records that provides optimal medical information service to a subscribed recipient by managing an integrated medical information processing system. The present invention provides total interoperability of patient medical records information to and from all present EHR/EMR electronic medical records base systems.

2. Brief Description of Prior Art

Comprehensive medical care often requires a patient to visit more than just one doctor. While many patients have established a long-standing relationship with their primary care provider, they are generally unfamiliar with more specialized doctors until medical circumstances necessitate a referral to one. Upon receiving a referral, the patient is usually left to arrange an actual appointment with the specialist. However the patient usually relies upon the patient's primary care provider to timely forward the patient's relevant medical records to the specialist prior to the scheduled appointment. There is little transparency in this process, and under unfavorable circumstances a patient may find himself/herself referred to a doctor who has not been given access to the necessary medical information relating to that patient due to slow delivery, mistaken delivery, and/or failure to deliver. These hurdles may cause delays in medical care, and in some cases even dissuade patients from complying with their primary care provider's recommendation to seek additional medical care from a specialist.

In telemedicine, consultations between patient/physician and remote physician are often being conducted without the benefit of the patient's medical history being available to the consulting remote physician. Additionally, existing EHR/EMR systems do not always communicate with each other whereby patient information can be exchanged.

Every other system known to applicant transmits PHI (data) using fax, e-mail and/or USPS. All of the above including e-mail with the use of encryption is less than ideal as it lends itself to be compromised and none of the above provide a secure method for the return of said data from the distant care provider (or system) whereby the data is returned to the sender (patient) in such a way as to be parsed and placed back into a patient medical records system in a structured format.

The problem does not end with the sharing of patient's medical records. There is no protocol for sharing of patient information between the primary and secondary care offices. The process requires someone to establish communications between one or more of the patient's primary care physicians and the secondary care physician(s). The inefficacies in managing this process are a drain on both the primary and secondary physician(s) offices. Often times, the patient, who has the least amount of medical knowledge and often an inability to anticipate or articulate the critical nature or timing of the referral, is left calling one or both offices and communicating with a receptionist who cannot independently determine what the next step in the process should be, without again involving either the primary or secondary care physician(s).

The issues described above have been long-standing problems for both physicians and patients, and substantially interfere with the ability to provide appropriate and cost effective medical care. Every existing electronic medical records based system known to applicant relies upon the health care institution and/or care provider to manage the patient's medical information independently.

The present invention provides total interoperability of patient medical records information between all present EHR/EMR electronic medical records based systems. In addition, the present invention solves the problems of interoperability between two disparate medical record systems.

### SUMMARY OF THE INVENTION

In one or more embodiments of the present invention, an apparatus and method are provided that allows patients, with the assistance of doctors and their administrative staff, to manage the process of physician referrals, whereby a patient is referred from one physician (primary care provider) to another physician (the referred-to or receiving physician or specialist) for a particular medical procedure, or analysis or care.

In the preferred embodiment, a system and method is available for sharing of patients medical records throughout the continuum of care involving all care providers, either primary and secondary care providers and/or facilities. The present system allows various means of communications and medical records transfer between multiple health care practitioner practice groups, multiple hospitals and multiple patients. The system's servers provide a network based service to the patient and all participating care providers, in order to allow the patient's medical records to be made available to selected physicians, practitioner groups, hospitals and medical specialists, by providing a web-based data processing service and interface to each of the participating medical providers, and can also communicate electronically via authenticated and encrypted email with each of these medical providers. In the alternative, the services provided to one or more practice groups, one or more hospitals, and/or one or more medical provider(s).

The present invention generally includes a personal health records web portal that provides the patient with ownership of their longitudinal medical history with the ability to transmit the patient's data to an in-network subscribing physician and/or an out-of-network medical provider (the referred-to consulting physician) and, a physician access web portal. The invention requires a web interface processor i.e. a personal computer, smart phone or other similar device. Further, the invention assumes that the disclosure's logical plug-in is associated with a Virtual Personal Health Records based software system known in the art.

The physician access web portal has the ability of being used by any subscribing physician in response to the request by the patient via encrypted message and email notifications. Upon receipt of a request to provide consultative services by the patient, the remote physician can be allowed access to the physician access web portal. Upon entering the access web portal, the physician can select the appropriate patient name, and a window opens that accesses the necessary medical records and a medical encounter worksheet, transmitted by the patient, in order for the physician to provide the requested consulting services.

The medical records provided to a specific licensed care provider, as described, are made available to the care provider without actually sending the Personal Health Information (PHI) directly to the care provider. Instead, the Information is accessible to the care provider by bringing the provider to the PHI (the physician access web portal) rather than physically sending the PHI to the care provider.

Upon completion of reviewing the medical data and recording their comments, suggestions and recommended orders, the remote physician closes the remote telemedicine window and the results are transmitted back to patient with notification via encrypted message and email. In addition, the system transmits all data submitted by the remote physician to the personal health records web portal of the patient.

This invention solves the problems of interoperability involving disparate medical record systems. Additionally, the present invention provides a means for patients (users) to choose what care provider they wish to work with and includes automatic notifications between patient and selected physician. The invention provides means from which to initiate telemedicine or telehealth from a patients web portal in connection with a personal health records based system using either of two methods; real-time video/audio interactive, called “synchronous” or store-and-forward, known as “asynchronous” in a secure manner and at the discretion and control by the patient with all records of medical services provided being returned and parsed back into the patient Virtual Personal Health Records based system.

These new features bring significant benefits to patients and doctors increasing the efficiency of their work flows and improving patient care while reducing administrative costs, and the probability of errors in patient care. The present system further provides a system and method for eliminating inefficacies in the sharing of patient information, enabling, for example, the referring doctor to track a patient's progress after treatment by a specialist, thereby eliminating uncertainty and allowing more effective treatment. In this regard, the system and method provides a sound system and method for reviewing a patient's progress after a referral appointment, by facilitating communications between the referring physician, the referred-to physician and all other care team members across the continuum of care.

### BRIEF DESCRIPTION OF THE DRAWINGS

FIG. 1 is one example of a webpage of the present system enabling a user/patient to select the medical reports and data files from the patient's personal health records to be transmitted to the referred-to physician.

FIG. 2 is one example of a webpage of the present system enabling a physician to access the patient information transmitted.

FIG. 3 is one example of a webpage of the present system enabling the referred-to physician to access those patient files submitted for review.

FIG. 4 is one example of a webpage of the present system enabling the referred-to physician to close the remote telemedicine window and transmit the referred-to physician's recommended orders (medications, tests, ect.) to the user (patient and/or point of care physician).

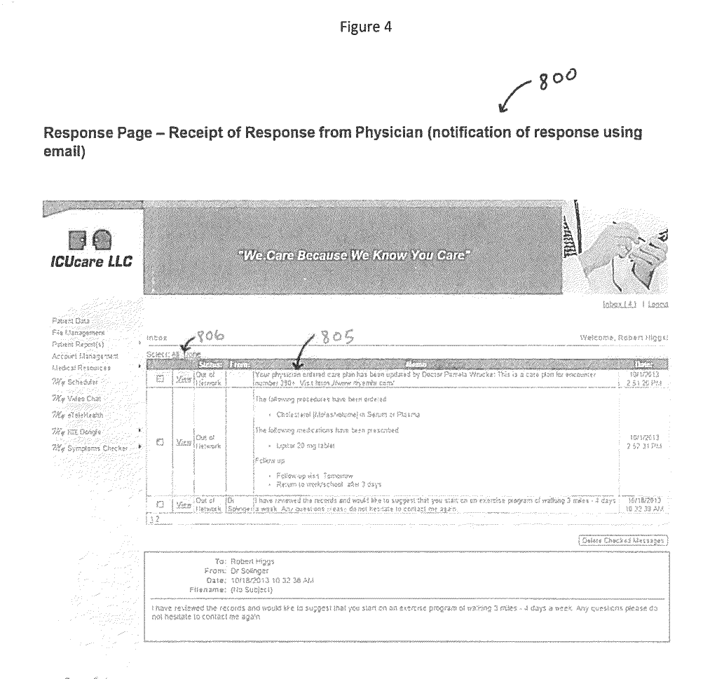

### DESCRIPTION OF THE PREFERRED EMBODIMENT

In the preferred embodiment of the present invention, an apparatus and method is provided that manages the medical records data of a patient across the continuum of care involving multiple care providers or medical institutions for the purposes of receiving medical services involving, but not limited to, the process of physician referrals, whereby a patient is referred from one physician (primary care provider) to another physician (the referred-to or receiving physician or specialist) for a particular medical procedure, or analysis or care. Unlike the prior art, the present invention is a multi-application records based platform that uses a Personal Health Records (PHR) as its foundation. The system is built on a patient-centered architecture that travels with the patient and is owned by the patient rather than the health care institution or medical care provide. As will be described, the present software platform as disclosed consists of components configured and correlated with respect to each other so as to attain the desired objective.

The present invention provides a means of transmitting a patient's complete health record to a specific licensed care provider without actually sending the personal health Information (PHI), and for the retrieval of all medical related data regarding services provided by care provider for insertion into a patient's virtual medical record in a secure manner.

In the preferred embodiment, the invention uses an NPI (National Physicians Identifier) physician database that works in connection with a web interface to provide means for the patient to search and retrieve any of over 2.5 million licensed care providers from which to contact regarding providing remote consultative services. The system uses a process whereby the software application generates a medical record in either C-CDA, CCR, CCD or CDA format (structured medical format) as required to provide interoperability with physicians existing medical record system and dynamically generates a one-instance web portal for use by the receiving physician to review the patient's request for services and the patient's medical history and subsequently enabling the distant physician to provide consultative medical services to the patient.

### Transfer of Patient Records

Over the course of a multi-doctor treatment process, a patient's medical records must often be transferred between several offices. Each of these transfers carries with it the possibility of document loss, and the frequent use of physical (paper) patient records only serves to increase this risk.

There is no widely used specialized procedure in place to efficiently facilitate transfer of records between healthcare providers either in private practices or Hospital-based physicians, meaning that a responsible patient and cooperative, well-organized practices must be present to ensure each doctor is properly informed. Three-way communication between the patient and multiple medical services locations is at best cumbersome, and at worst ineffective in ensuring that records are transferred completely and in a timely fashion. Breakdowns in communication and record transfers can lead to unnecessary procedures, inappropriate medication, preventable deaths, and superfluous testing that combine to create additional cost for patients and insurance providers, all the while eroding trust in medical providers and causing frustration on all sides.

The present invention is directed to a solution that provides for the capture, storage, retrieval and transmission of patients medical records including longitudinal history and imaging throughout the healthcare system environment. The present system resolves problems associated with interoperability between existing and legacy health records systems by providing one central all-inclusive repository of patient data by way of a cloud-based personal health records software solution with the ability to generate a continuity of care document in a format as described above that is capable of being parsed into any disparate medical health records system and the ability to retrieve and receive a continuity of care documents in such structured format as previously identified back to the central repository whereby the data is parsed back into the patient record based system.

According to the preferred embodiment of the invention described below, a method and apparatus are provided which allows a patient to make his/her necessary medical information available to referred-to physicians and different practice groups. Furthermore, the referring doctor can track a patient's progress after treatment by a specialist, eliminating uncertainty and allowing for more effective treatment at their next meeting. Document loss becomes a non-issue, as digitally archived documents cannot be lost or misplaced.

In this regard, the present invention discloses means for sending PHI (Personal Health Information) to a distant care provider for their use in providing medical services with full and complete knowledge of the patient's medical history. The present invention accomplished this objective without actually sending PHI by use of the one-instance physician access web portal with notification whereby the distant care provider is brought to the PHI versus sending the PHI to the care provider via fax, e-mail and/or USPS. This represents a radically new process for the transfer of PHI and other patient confidential information.

The present system generally includes a personal health records module and a physician access module. The present invention requires a web interface processor, i.e., a personal computer, smart phone or similar device. Further, the present invention assumes that the disclosure's logical plug-in is associated with a Virtual Personal Health Records based system known in the art.

The personal health record module serves as the primary records-based delivery component of the present system. All point-of-care patient and care provider interaction is driven and recorded by this application. It provides complete capture, storage, retrieval, recording and transmission capabilities of all patient and physician data as will be described.

The Personal Health Records module serves as the central repository for all patient medical records. The Personal Health Records module receives, stores, and transmits from, all patient medical data and records.

The Physicians Access module is for use in connection with remote medical consultations with the ability to transmit patient data in a store-forward fashion and supported by live video/audio technologies that are embedded within the system and inter-connected with the Personal Health Records module. The Physicians Access module has the ability of being used by any subscribing or non-subscribing physician in response to the request by the patient via encrypted message and email notifications.

The transfer of medical records to the Physicians Access module is initiated by the patient. The user (patient) would select a physician from various internal sources. The system enables the user to conduct a search by physician's last name, state of residence and other data elements and returns the contact information including the physician's address, phone number, NPI number for use by user to contact and request a valid e-mail address for use in sending notification. Upon securing the chosen physician's e-mail address, the user would then select what medical data in addition to all structured data required by the remote or distant care provider from the patient's personal health records module, input a message or instructions as to the purposes of the consultation, and then transmit an encrypted message and email to the remote physician.

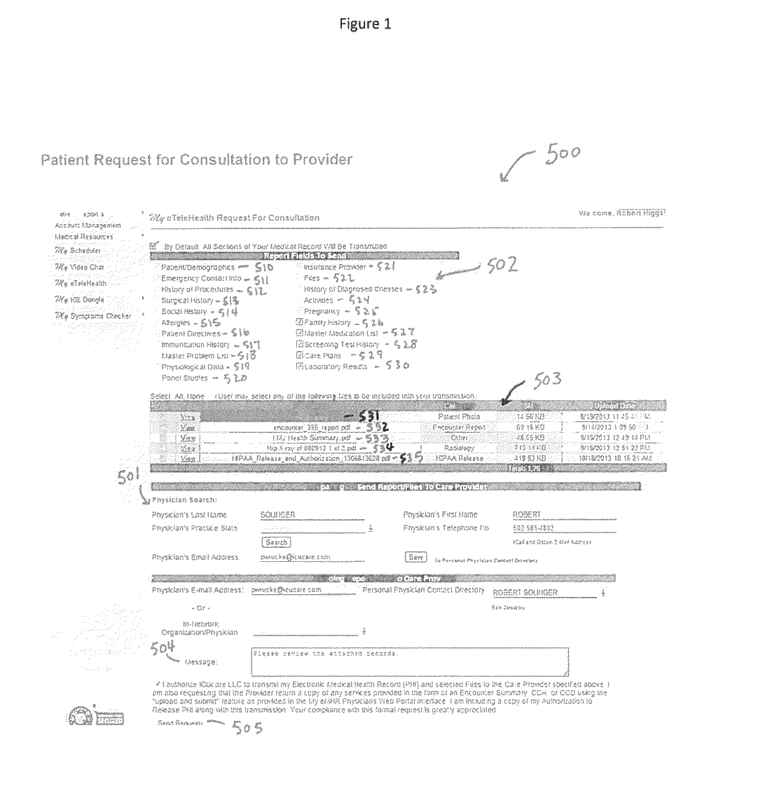

FIG. 1 is an example of a webpage 500 enabling a patient to select a physician 501 from various internal sources, select what additional medical data should be made available to the remote or distant care provider 502 and 503, input a message or instructions 504 as to the purpose of the consultation, and then send 505 the encrypted message and e-mail to the selected remote physician.

As illustrated in FIG. 1, and as an example, the patient has elected to include the Report data fields 510-530. The user enters the appropriate information by selecting the fields 510-530 to be updated for transmittal, thereby initiating the transfer of the selected data. Not all items (data files and records) are required to be selected, rather the user can pick among the report fields (designated numerals 510-530 in FIG. 1). Similarly, the user selects the data files listed 503 to be included with the transmission. Within the data file box 503 the user is able to select from the patient's data what files to be made available to the, for example, referred-to physician.

The data file box 503 lists all the patient's medical data files. The user enters the appropriate information by selecting the files to be uploaded for transmittal, thereby initiating the transfer of medical records process. Not all items (data files and records) are required to be selected, rather the user can pick among the data files available (designated numerals 531-535 in FIG. 1). As one example, the patient could select the image file 531 and the encounter report 532 and the hip x-ray 534 to be uploaded and transmitted.

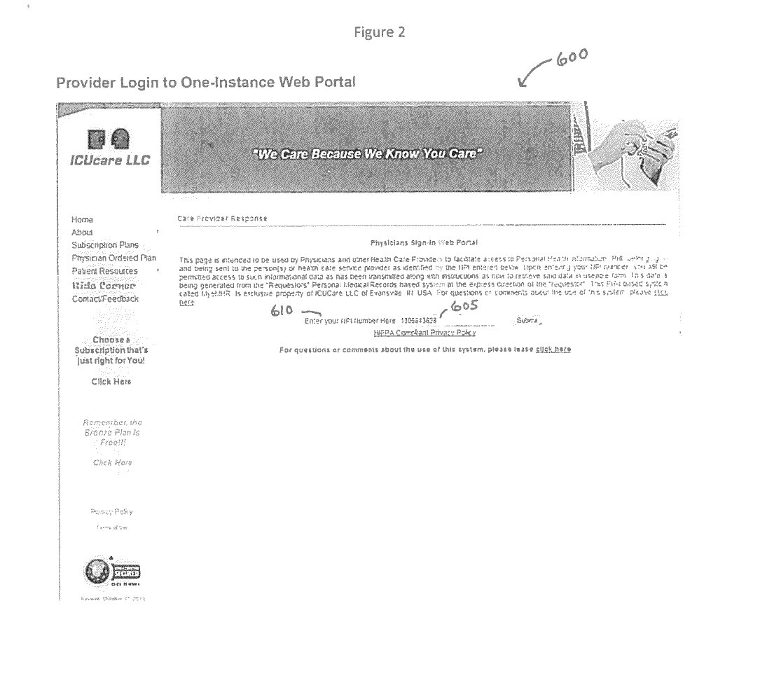

Upon receipt of a request to provide consultative services, the remote physician responds (clicks) on a web link as provided in the message/email, and the remote physician is then directed by the system to a secure personal web portal. Referring to FIG. 2, which is a webpage for enabling a physician to access the patient information, the remote physician is required to respond 605 to security question(s) such as, in the preferred embodiment, the physician's NPI (National Identifier Number) number 610. The system then authenticates the user's NPI with a cloud based NPI database containing all licensed care providers in North America. The database is updated each month to account for additions, deletions or other changes in care provider information.

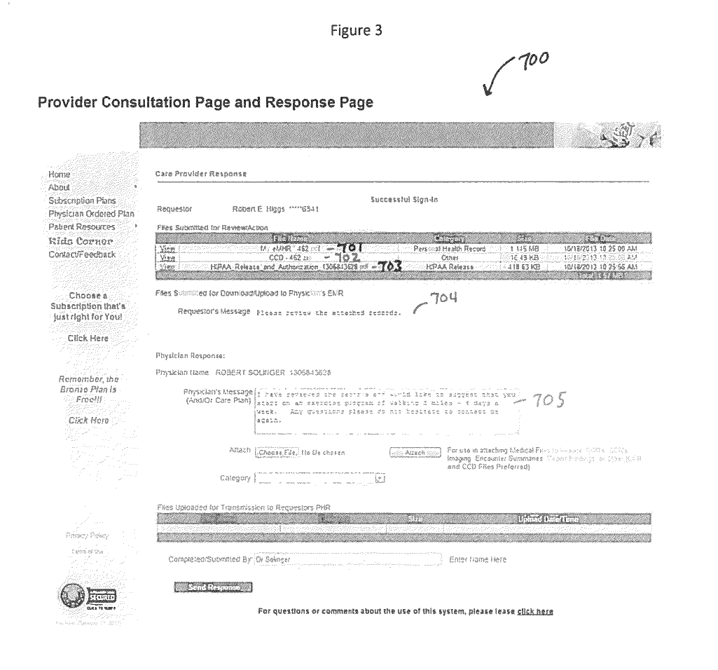

Upon entering the correct security information, the remote physician is then directed to their own private web portal (physicians access module) within the system. Upon entering their web portal, they will see all open consultation requests for services. The remote physician can then electronically select the appropriate patient name and a window opens 700 that accesses all of the patient's longitudinal medical information to Include imaging or other related patient data files required for the secondary care physician for use in providing the consulting services requested. FIG. 3 shows an exemplary webpage 700 after the physician's successful sign-in, for accessing those files submitted for review 701-703, along with the user/patient's message or instructions 704 to the remote physician.

All medical data is also made available in structured form using the NIST standard for CCR, CCD, CDA or C-CDA for use by the remote physicians in downloading said data into their respective disparate operating system. As a result, the present invention has the ability to allow a user to append medical files of any known format to the CCR/C-CDA/CCD/CDA transfer document(s) for use by physician in providing diagnosis.

In the preferred embodiment, once the physician is able to access the transmitted patient files by providing accurate security, the system generates a one-instance custom web portal for use by physician in viewing, downloading and providing the medical services request. Inside the web portal, the physician has the ability to view, download and upload returned files to the patient's health records module with the ability to include instructions or orders of care. In this regard, the system provides the distant physician the ability to upload C-CDA/CCRICCD/CDA and associated files to the one-instance web portal for return to patient's system, and to send a notification via e-mail back to the patient/user of the response by the distant physician. The data files returned by the distant physician to the patient's health medical records module, along with any appended data files, are returned in a structured data format with the ability to be easily parsed back into the patient virtual personal health records based system.

The present system provides the ability of the medical data received from the remote physician to include imaging from any EMR/EHR in the structured format and parse (process) that received medical data by processing the structured data for inclusion in the user's personal health records module.

### Post-Referral Reporting on Doctors

By referring patients to another physician, a doctor effectively grants a colleague access to trust-based doctor-patient relationships that form the core of his/her business. It is accordingly in the referring doctor's interest, both from a professional standpoint and with a view to his or her own reputation, to ensure that patients referred elsewhere receive care quickly and efficiently, and that they are satisfied with their patient experience. Without a tool to systemically track post-referral care, doctors rely on intuition when deciding where to refer their patients. Other than time consuming individual follow-ups to every referral, there is little a doctor can do to gain an overview of and assess the doctor-patient relationships being built between “his” or “her” own patients and the specialist he or she refers to.

Comprehensive reporting on referrals and follow-up is a central feature of the present system. This allows doctors to more objectively evaluate professional relationships, which in turn should create benefits for patients hoping to be referred to reliable and confident doctors. Practices deficient in sharing documents or making use of information shared can be more easily identified.

In the present invention upon completion of reviewing data and recording their comments and suggestions 705 and recommended orders (medications, tests, ect.) 805 the remote physician closes the remote telemedicine window and the results 805 are transmitted back to the patient or primary physician of record via encrypted message and email. The system further includes a reconciliation process where the data received from the remote physician 705, 805 is logically compared with the data in the user's personal health records module to avoid duplication. In this regard, the reconciliation process is both automatic and manual in that all data received is brought to a user webpage screen and presented to the user with both existing data and newly received data so that the user can either accept or reject the inclusion (into the personal health records module) of the newly received data 705, 805 at the user's discretion.

At the conclusion of the remote consultative medical encounter, the physician's web portal transmits all data to the patient's personal health records module. Should the patient decide to secure a second opinion or simply visit another care provider, the patient transmits or downloads any and all of their medical records including imaging to the next care provider with the ability of collecting all data from the provider for a return to their all-inclusive personal health records based system.

As should be understood, the described components of the present system are relationship database driven. The logic gateways have been developed to provide automated notifications to respective parties (patients and medical care providers) based on thousands of user actions representing data received with corresponding actions to be taken regarding medications, laboratory, immunizations, procedures, radiology, problems, treatments and other instructions.

It is critical to note that the use of the personal health records based system is independent of the medical care provider's own electronic medical records system but yet, capable of communicating with that system or any other medical records based system. This is the founding principle of the present system that cannot be altered.

The personal health records module serving as the central repository for all patient medical records across the complete spectrum of the global health care environment. As such, this solution provides the ability to capture, receive, parse, store and transmit any/all data to and from the personal health records module to physician access module in an integrated fashion. Similarly, the physician access module provides the ability to accept, access patient data from the personal health records module for the expressed benefit of providing consultation services and to record all such services and transmit said data back to either the personal health records module.

The present disclosure relates to a system and method for processing medical information, and more particularly, to a system that provides optimal medical information service to the patient and the care provider by managing an integrative medical information processing system independently operated using a cloud system.

Domestic medical information processing technology includes Picture Archiving Communication System (PACS), Order Communication System (OCS), and Electronic Medical Record (EMR), which comply with Health Level 7 (HL7). Medical information processing is independently managed by individual hospitals. Particularly, EMR has been developed into the Electronic Health Record (EHR) concept that is a lifetime electronic health record of individual patients.

However, EHR independently operated need to be integrated according to standardization for high quality medical service of individuals. For this, integrated system technology is needed, and for example, a cloud computing model is being applied.

Cloud computing is a next generation computing technology in which Software as a Service (SaaS) for web 2.0 service and utility computing are complexly combined.

The service structure of cloud computing may include a server for using IT environment, storage, Infrastructure as a Service (IaaS), Platform as a Service for providing a basis for development of software, Software as a Service (SaaS) in which a computing provider supplies and uses software through Internet. The present system may further include mobile browser technology which is a software-manufacturing technology with an app structure used to independently provide developed services to a user in a smart environment.

As used herein, database is meant to include any of various types of data repositories and processes for indexing, searching, storage and retrieval from such repositories.

An e-mail and text messaging module allows encrypted e-mails and text messaging with authentication to be sent to/from patients, physicians, practice groups, hospitals, via the respective server/computer. The e-mails can be sent manually by a person operating the server and can be automatically generated by the server. For example, the e-mail module can be configured to automatically query the database module and send e-mail messages to entities identified in the database module.

The software may include standard APIs so data and other information can be exchanged with other software systems. The system can further include a DICOM viewer module for viewing and processing “native” DICOM imaging from any known source, for both the personal health records module and the physicians module.

Physicians and Practice Groups In various embodiments of the present invention disclosed herein, the term “physicians”, “care providers” or “doctor” refers to a physician administering patient care, as well as to those members of his/her staff responsible for maintaining the physician's patient records. Though the term is used interchangeably, it should be understood that in the exemplary figures and texts, each function is being performed by one or more persons that perform such activities in a particular doctor's office on behalf of a licensed physician.

The term “specialist” is applied to a physician administering secondary care to a patient after a referral from a referring physician, and is also applied to other members of his/her staff in the same manner as is done for the physician. It may be possible for any given physician to in one situation be a specialist (receiving a patient via referral), and in another be a primary care physician (referring a patient to another physician for specialized care).

Further a “provider group” or “practice group” may be any entity linking a group of doctors through shared facilities, services, or referral agreements. This can include but should not be limited to integrated multi-facility hospitals, medical groups, and multi-doctor practices.

### System, Method and Computer Program

As will be appreciated by one skilled in the art, the present invention may be embodied as an apparatus or method, including a computer system or computer program product. Furthermore, the present invention may take the form of a computer program product embodied in any tangible medium of expression having computer-usable program code stored in the medium.

Any combination of one or more computer-usable or computer-readable medium(s) may be utilized, unless specified to the contrary herein. The computer-usable or computer-readable medium may be, for example, but not limited to, electronic, magnetic, optical, electromagnetic, infrared, or semiconductor storage mediums. More specific examples (a non-exhaustive list) include: a portable computer diskette, a hard disc, a random access memory (RAM), a read-only memory (ROM), an erasable programmable read-only memory (EPROM or Flash Memory), and a portable compact disc read-only memory (CDROM), an optical storage device.

Further, the present invention is described above with reference to flowchart illustrations and/or block diagrams of methods, apparatus and computer program products (systems) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprise one or more executable instructions for implementing the specified logical function(s). It should also be noted that, in some alternative implementations, the functions noted in the block may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart Illustration, and combinations of blocks in a block diagrams and/or flowchart illustration, can be implemented by special purpose hardware-based systems that perform the specified functions or acts, or combinations of special purpose hardware and computer instructions.

Although the above description contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

I claim:

1. An online system for transmitting patient medical records, comprising:
a cloud system,
a user terminal to allow a user to use a medical information processing service, and inducing access to the cloud system taking charge of medical information processing,
a personal health records module, and
a physician's module,
wherein said personal health records module for receiving and managing patient records and transmitting selected patient records to said user terminal and said physician's module, and
wherein said physician's module for receiving selected patient records from said user terminal and said personal health records module and transmitting selected data to said user terminal and said personal health records module,
said user terminal further including a user interface enabling the user to select patient records on said personal health records module and transmitting said selected patient records to said physician's module,
wherein said system includes a security module to authenticate a physician user's security before allowing the physician user access to said transmitted selected patient records.

2. The online system as recited in claim 1, wherein said selected patient records are transmitted to the cloud system in real-time.

3. The online system as recited in claim 2, wherein the user terminal module includes an interface function of accessing said cloud system and a function of outputting, managing, and software processing an event generated by the personal health records module and the physician's module.

4. The online system as recited in claim 3, further including a platform connection module that provides a function of connecting between platforms for managing the cloud system for medical information processing and information resourced and allows a user terminal comprising a function of virtualizing resources necessary for service processing to access the cloud system.

5. The system as recited in claim 4 wherein said security is the physician user's National Identifier Number.

6. The system as recited in claim 5, further enabling the physician user to form a response which response includes said selected patient records, and transmit said response to the user.

7. The online system as recited in claim 6, further including reconciliation means to compare the response with the patient records on the personal health records module.

8. The system as recited in claim 7, further including means to merge the response with the personal health records module.

9. An online transfer of patient medical records apparatus comprising:
an application software stored on a web access to cloud device, said web access to cloud device for connecting and communicating with a personal health records module and a physician's module, wherein said personal health records module is accessible by a user, and said physician's module is accessible by the user and a distant care provider,
said application software defining a platform enabling the user to transmit selected patient records via the Internet from the personal health records module to the physician's module for review by the distant care provider based on a filtered combination of the available personal health records,
wherein said platform includes means for generating an encrypted message and e-mail notification to the distant care provider, and wherein
said encrypted message includes a web link directing the distant care provider to a secure web portal such that the distant care provider is required to answer a security question(s) before accessing the physician's module containing the selected patient records.

10. The apparatus as recited in claim 9, wherein said selected patient records is in a structured form.

11. The apparatus as recited in claim 10, wherein said selected patient records are transmitted from said web access to cloud device to a cloud system in real-time.

12. The apparatus as recited in claim 11, further including means for said distant care provider to transmit a response to the user via the Internet after reviewing said selected patient records.

13. The apparatus as recited in claim 12, wherein said response is transmitted to the personal health records module, and said response is in said structured form.

14. The apparatus as recited in claim 13, further including reconciliation means to compare the response of the distant care provider with the personal health records module.

15. The apparatus as recited in claim 9, wherein the web access to cloud device is a personal computer.

16. The apparatus as recited in claim 9, wherein the web access to cloud device includes an interface function of accessing said cloud system and a function of outputting, managing, and software processing an event generated by the personal health records module and the physician's module.

17. A method for online transferring of patient medical records from a user to a distant care provider compromising the steps of:
a user forming a transmission to be sent via the Internet to a distant care provider by performing the following steps:
finding a selected distant care provider's contact information including name, address, phone, e-mail and NPI,
accessing a personal health records module through a web enabling device for selecting and transmitting the user's medical records via the Internet to a physician's access module based on a filtered combination of the available user's medical records,
sending the transmission that includes an encrypted message and e-mail notification to the distant care provider, wherein said encrypted message includes a web link to a secure web portal;
the direct care provider performing the following steps via the Internet:
opening the encrypted message and e-mail,
opening said web link to said secure web portal,
responding to at least one security question,
accessing the selected medical records in the secure web portal,
viewing and evaluating the selected medical records,
responding to the transmission including instructions and/or orders of care;
the user performing the following steps:
creating an accepted data file by reconciling the response of the data care provider with the user's personal health records module,
transmitting the accepted data file to the personal health records module.

18. The method as recited in claim 17, wherein said direct care provider transmits said response via the Internet.

19. The method as recited in claim 18, further comprising the step of the distant care provider transmitting said response to a primary care provider of said user.
